(19) United States
(12) Patent Application Publication
(10) Pub. No.: US 2016/0216861 A1
(43) Pub. Date: Jul. 28, 2016

(54) Method for Changing Touch Control Function for Smartphone and Touchscreen Computer

(71) Applicants: Hao-Hsun Hou, Taipei City (TW); Kun-Yuan Lin, Taipei City (TW)

(72) Inventors: Hao-Hsun Hou, Taipei City (TW); Kun-Yuan Lin, Taipei City (TW)

(73) Assignee: I/O INTERCONNECT INC., Taipei City (TW)

(21) Appl. No.: 14/862,232

(22) Filed: Sep. 23, 2015

Related U.S. Application Data
(63) Continuation-in-part of application No. 14/607,046, filed on Jan. 27, 2015.

(51) Int. Cl. G06F 3/0486; G06F 3/041; G06F 3/0488; G06F 3/14

(52) U.S. Cl. CPC G06F 3/0486; G06F 3/1454; G06F 3/0412; G06F 3/0488

(57) ABSTRACT

The invention provides a method for changing a touch control function when a smartphone is connected to a computer with a touchscreen. The method includes the steps: a) operationally connecting the desktop computer to the handheld touchscreen computer to project a screen picture of the handheld touchscreen computer on the touchscreen, wherein the screen picture contains a first item, and a second item corresponding to the first item is shown on the touchscreen; b) pressing and holding the second item for more than one second; c) sending a touch event about the operation to the second item from the desktop computer to the handheld touchscreen computer; and d) performing a pressing-and-holding operation to the first item by the handheld touchscreen computer according to the touch event.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

The invention relates to handheld touchscreen computers such as smartphones and tablet computers, particularly to the connection between a handheld touchscreen computer and a personal computer with a touchscreen.

2. Related Art

Handheld touchscreen computers, such as smartphones and tablets, have become essential for most people. Some users of handheld touchscreen computers have the need to connect their handheld touchscreen computer to an external monitor that serves as a larger display. In some cases the external monitor is a desktop touchscreen computer. When a handheld touchscreen computer is connected to a desktop touchscreen computer, and a screen picture of the handheld touchscreen computer is projected on the desktop touchscreen computer, users are still able to utilize touch control functions of the desktop touchscreen computer as though they were directly operating a handheld touchscreen computer.

However, an operating system used in a desktop touchscreen computer, such as MICROSOFT WINDOWS, has natively defined functions with respect to various touch operations such as swiping, tapping, sliding to scroll, dragging to rearrange, and pinching or stretching to zoom. For example, a desktop touchscreen computer with MICROSOFT WINDOWS will show information to help a user learn more about an item or open a menu specific to what a user is doing when the item is being pressed and held for about one second. It is the same as right-clicking with a mouse on a desktop or a laptop computer. This response is distinctly different from a handheld touchscreen computer, however.

An ANDROID-based handheld touchscreen computer will initiate dragging an item when the item is being pressed and held for more than one second. Such difference in response to two seemingly identical operations as applied to two different operating systems almost always confuses and annoys users of handheld touchscreen computers because they would still feel that they are operating a handheld touchscreen computer. However, as yet there is no solution on the market to effectively diffuse this confusion.

### SUMMARY OF THE INVENTION

An object of the invention is to provide a method for changing a touch control function for a handheld touchscreen computer and a desktop touchscreen computer, which can effect a change of response from the right-clicking of mouse to the initial dragging of an item shown on the touchscreen computer when the item is being pressed and held for more than one second. In other words, operating a desktop touchscreen computer which is connected to a handheld touchscreen computer that projects a screen picture of the handheld touchscreen computer is the same as operating a desktop touchscreen computer when a user presses and holds an item shown on the desktop touchscreen computer. The invention will make users of handheld touchscreen computers no longer confused (and annoyed) when they connect their handheld touchscreen computers to desktop touchscreen computers.

To accomplish the above object, the method of the invention includes the steps of: a) operationally connecting the desktop computer to the handheld touchscreen computer to project a screen picture of the handheld touchscreen computer on the touchscreen, wherein the screen picture contains a first item, and a second item corresponding to the first item is shown on the touchscreen; b) pressing and holding the second item for more than one second; c) sending a touch event about the second item from the desktop computer to the handheld touchscreen computer; and d) performing a dragging operation to the first item by the handheld touchscreen computer according to the touch event.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

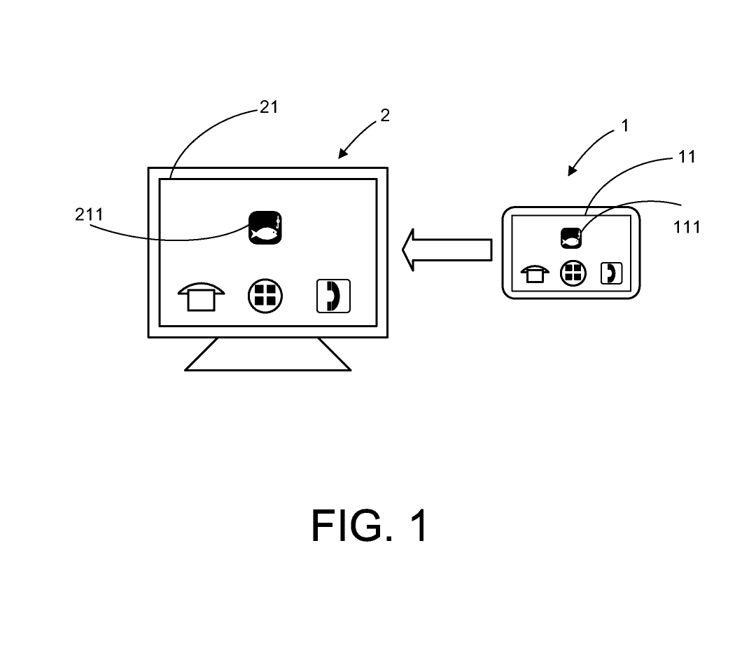

Please refer to FIG. 1. The invention provides a method for changing a touch control function for a handheld touchscreen computer 1 and a desktop touchscreen computer 2. The handheld touchscreen computer 1 may be a smartphone or a tablet computer. Of course, the handheld touchscreen computer 1 and the desktop touchscreen computer 2 and must be provided with a first touchscreen 11 and a second touchscreen 21, respectively.

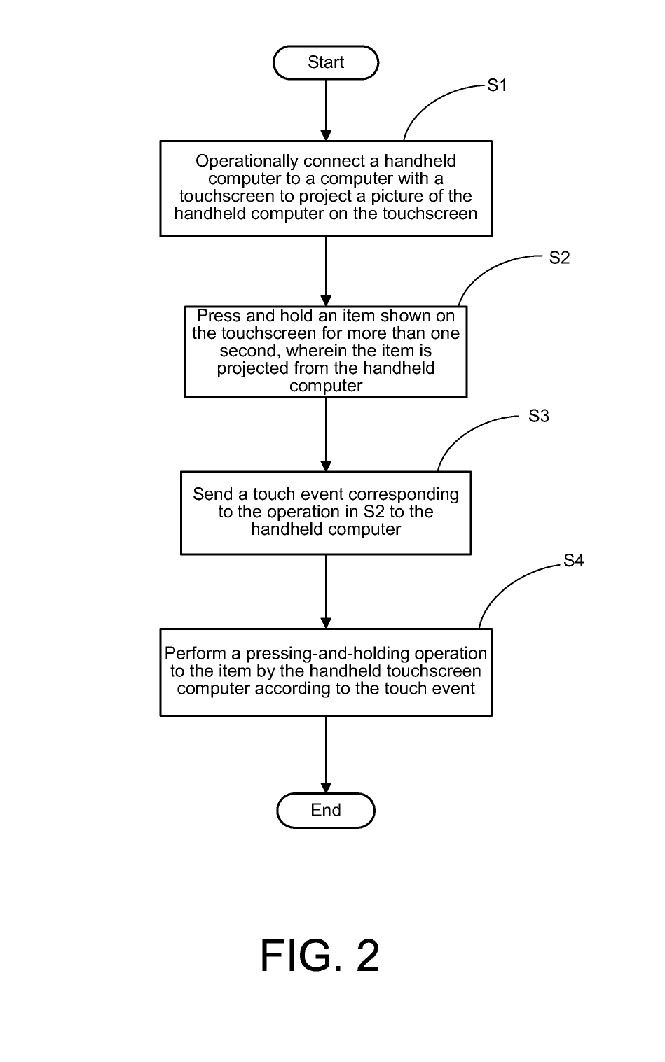

Please refer to FIG. 2, which shows a flowchart of the method of the invention. In step S1, the desktop touchscreen computer 2 is operationally connected to the handheld touchscreen computer 1 to project a screen picture of the first touchscreen 11 of the handheld touchscreen computer 1 on the second touchscreen 21. The screen picture of the handheld touchscreen computer 1 contains a first item 111, and a second item 211 corresponding to and the same as the first item 111 is shown on the second touchscreen 21. The connection between the handheld touchscreen computer 1 and the desktop touchscreen computer 2 may be wired or wireless. The wired connection may be a USB (universal serial bus) cable or an HDMI (high definition multimedia interface) cable, and the wireless connection may utilize the BLUETOOTH or Wi-Fi communication protocol. In step S2, a user presses and holds the second item 211 shown on the second touchscreen 21 for more than one second. In step S3, the desktop touchscreen computer 2 sends a touch event corresponding to the operation to the second item in step S2 to the handheld touchscreen computer 1. Finally, in step S4, the handheld touchscreen computer 1 performs a pressing-and-holding operation to the first item 111 according to the touch event. For example, the pressing-and-holding operation may initiate dragging of an item. Accordingly, the dragging of the second item 211 on the second touchscreen 21 will be performed.

The invention offers a great convenience to users by assimilating non-identical operations between a handheld touchscreen computer and a desktop touchscreen computer when they have been operationally connected.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for changing a touch control function for a handheld touchscreen computer and a desktop computer with a touchscreen, comprising the following steps in the order named:
a) operationally connecting the desktop computer to the handheld touchscreen computer to project a screen picture of the handheld touchscreen computer on the touchscreen, wherein the screen picture contains a first item, and a second item corresponding to the first item is shown on the touchscreen;
b) pressing and holding the second item for more than one second;
c) sending a touch event about an operation to the second item in step b) from the desktop computer to the handheld touchscreen computer; and
d) performing a pressing-and-holding operation to the first item by the handheld touchscreen computer according to the touch event.

2. The method of claim 1, wherein the handheld touchscreen computer is a smartphone or a tablet computer.

3. The method of claim 1, wherein a connection between the handheld touchscreen computer and the desktop computer is a wired link.

4. The method of claim 3, wherein the wired link is a USB (universal serial bus) cable or an HDMI (high definition multimedia interface) cable.

5. The method of claim 1, wherein a connection between the handheld touchscreen computer and the desktop computer is a wireless link.

6. The method of claim 1, wherein the wireless connection is a BLUETOOTH or Wi-Fi communication protocol.

7. The method of claim 1, wherein the pressing-and-holding operation in step d) is dragging the first item.
